(19) United States
(12) Patent Application Publication
(10) Pub. No.: US 2009/0071882 A1
(43) Pub. Date: Mar. 19, 2009

(54) SPHERICAL BODY SORTER AND SPHERICAL BODY SORTING APPARATUS USING THE SAME, AND SPHERICAL BODY SORTING METHOD

(75) Inventor: Kei Murayama, Nagano-shi (JP)

Correspondence Address: DRINKER BIDDLE & REATH (DC), 1500 K STREET, N.W., SUITE 1100, WASHINGTON, DC, 20005-1209, US

(73) Assignee: SHINKO ELECTRIC INDUSTRIES CO., LTD., Nagano-shi (JP)

(21) Appl. No.: 12/182,606

(22) Filed: Jul. 30, 2008

(30) Foreign Application Priority Data
Aug. 1, 2007 (JP) 2007-200289

(51) Int. Cl. B07C 5/34

(52) U.S. Cl. 209/684

(57) ABSTRACT

A spherical body sorter for sorting spherical bodies having a predetermined diameter dimension is made by opening multiple concave parts in the side of one surface of a plate-shaped body made of single-crystal silicon. Each of the concave parts formed in the spherical body sorter is formed in the same shape and dimension.

### TECHNICAL FIELD

The present disclosure relates to a spherical body sorter and a spherical body sorting apparatus using this sorter, and a spherical body sorting method.

### RELATED ART

A diameter of a solder ball used in a semiconductor apparatus has become smaller with miniaturization and thinning of the semiconductor apparatus in recent years. Before such a solder ball with a small diameter is installed in the semiconductor apparatus, the solder balls are often screened and used.

A spherical body sorting apparatus (for example, Patent Reference 1) in which recesses (concave parts) for burying spherical bodies are formed on a substrate and also an air suction apparatus is connected to the recesses and the spherical bodies to be sorted are sucked into the recesses by air and thereafter only the spherical bodies which are not sucked into the recesses by air are removed and thereby the spherical bodies are screened every predetermined particle diameter has been provided as a sorting apparatus of a spherical body typified by a minute solder ball.

[Patent Reference 1] Japanese Patent Application Publication No. 2003-236475

However, a particle diameter of a solder ball used in a recent semiconductor apparatus is often a particle diameter of 100 μm or less and there is a problem that it becomes difficult to form recesses capable of accurately screening the solder balls on a substrate.

Also, there is a problem that it is difficult to surely connect an air suction apparatus to each of the recesses for separating such spherical bodies with very small diameter dimensions and a cost of providing a spherical body sorting apparatus increases.

### SUMMARY

Exemplary embodiments of the present invention provide a spherical body sorter capable of accurately sorting fine spherical bodies as used in a semiconductor apparatus every predetermined particle diameter and being provided at low cost, and a spherical body sorting apparatus using this sorter and a spherical body sorting method.

A first invention in the invention of the present application is a spherical body sorter for sorting spherical bodies having a predetermined diameter dimension, and is the spherical body sorter wherein the spherical body sorter is made by opening multiple concave parts in the side of one surface of a plate-shaped body made of single-crystal silicon and each of the concave parts is formed in the same shape and dimension.

Also, it is wherein the plate-shaped body made of the single-crystal silicon is a single-crystal silicon wafer. Consequently, the plate-shaped body for manufacturing the spherical body sorter is available at low cost and the spherical body sorter can be provided at low cost.

Also, it is wherein in the plate-shaped body made of the single-crystal silicon, a plane orientation is a plane (100).

Also, it is wherein the concave part has a quadrangular pyramid shape, and it is wherein the concave part is formed by performing wet etching with respect to the plate-shaped body made of the single-crystal silicon.

Consequently, the concave parts can easily be made the same opening shape, opening dimension and depth dimension, so that the spherical body sorter having the concave parts with high accuracy can be provided at low cost.

Also, a first invention of a spherical body sorting apparatus includes a spherical body sorting apparatus comprising a spherical body supply section for supplying spherical bodies to the spherical body sorter, a vibrator for giving vibration to the spherical body sorter, an inclination giving section for inclining the spherical body sorter, a spherical body reception part for individually receiving the spherical bodies sorted by the spherical body sorter, and a control part for executing a sorting processing in which after the spherical body supply section supplies spherical bodies to the spherical body sorter, vibration is given to the spherical body sorter to which the spherical bodies are supplied by the vibrator and the spherical body sorter to which the spherical bodies are supplied is inclined by the inclination giving section and thereby receiving the spherical bodies in the spherical body reception part.

Further, a second invention of a spherical body sorting apparatus includes a spherical body sorting apparatus comprising the plurality of spherical body sorters arranged in series in a direction of sorting processing of the spherical bodies to stepwise sort spherical bodies, a spherical body supply section for supplying the spherical bodies to the spherical body sorters, a vibrator for individually giving vibration to the plural spherical body sorters, an inclination giving section for individually inclining the plural spherical body sorters, a spherical body reception part for individually receiving the spherical bodies sorted by the plural spherical body sorters, and a control part for executing a sorting processing in which after the spherical body supply section supplies spherical bodies to the spherical body sorters, vibration is given to the spherical body sorters to which the spherical bodies are supplied by the vibrator and the spherical body sorters to which the spherical bodies are supplied are inclined by the inclination giving section and thereby receiving the spherical bodies in the spherical body reception part.

Also, it is wherein dimensions of the concave parts disposed in the plural spherical body sorters become larger or smaller stepwise in the direction of sorting processing of the spherical bodies.

Also, it is wherein spherical bodies received in the spherical body reception part are supplied to another spherical body sorter arranged in the downstream side of a spherical body sorter for sorting the spherical bodies and the control part executes the sorting processing with respect to the another spherical body sorter.

By adopting these configurations, the spherical bodies to be sorted can be sorted in plural steps.

Also, it is wherein the plural spherical body reception parts are arranged for the one spherical body sorter and in the case of executing the sorting processing, the control part executes the sorting processing in which spherical bodies which are not captured in concave parts of the spherical body sorter are received in a first spherical body reception part by inclining the spherical body sorter to which the spherical bodies are supplied at a first inclination angle by the inclination giving section and thereafter the spherical bodies captured in the concave parts of the spherical body sorter are received in a second spherical body reception part by inclining the spherical body sorter to which the spherical bodies are supplied at a second inclination angle with an inclination steeper than the first inclination angle. Consequently, the spherical bodies captured in recesses can easily be separated from the spherical bodies which are not captured in the recesses without using an air suction apparatus etc.

According to the invention, a spherical body sorter is constructed by simply forming only concave parts in a plate-shaped body made of single-crystal silicon, so that an incidental apparatus such as an air suction apparatus etc. is not required. Also, the concave parts for sorting spherical bodies can uniformly be formed at low cost, so that even in the case of a spherical body sorter for sorting very fine spherical bodies and a spherical body sorting apparatus using this sorter, the spherical body sorter and the spherical body sorting apparatus can be provided at low cost.

Other features and advantages maybe apparent from the following detailed description, the accompanying drawings and the claims.

### BRIEF DESCRIPTION OF THE DRAWINGS

FIG. 1 is a plan view of a solder ball sorter used in a solder ball sorting apparatus in a first embodiment.

FIG. 2 is sectional views taken on line A-A and line B-B in FIG. 1.

FIG. 3 is a schematic configuration view of the solder ball sorting apparatus in the first embodiment.

FIG. 4 is a view showing a state of the solder ball sorting apparatus in each of the steps of a solder ball sorting method in the first embodiment.

FIG. 5 is a view showing a state of the solder ball sorting apparatus in each of the steps of the solder ball sorting method in the first embodiment.

FIG. 6 is a view showing a state of the solder ball sorting apparatus in each of the steps of the solder ball sorting method in the first embodiment.

FIG. 7 is a view showing a state of the solder ball sorting apparatus in each of the steps of the solder ball sorting method in the first embodiment.

FIG. 8 is a flow view showing a procedure of the solder ball sorting method in the first embodiment

FIG. 9 is a schematic configuration view of a solder ball sorting apparatus in a second embodiment.

### DETAILED DESCRIPTION

Embodiments of a spherical body sorter according to the invention and a spherical body sorting apparatus using this sorter will hereinafter be described in detail based on the drawings.

### First Embodiment

### (Solder Ball Sorter)

In the present embodiment, a solder ball sorter using a solder ball as a spherical body and a solder ball sorting apparatus using this sorter will be described, and the spherical body in the invention is not limited to the solder ball and other spherical bodies can naturally be applied in a manner similar to the embodiment.

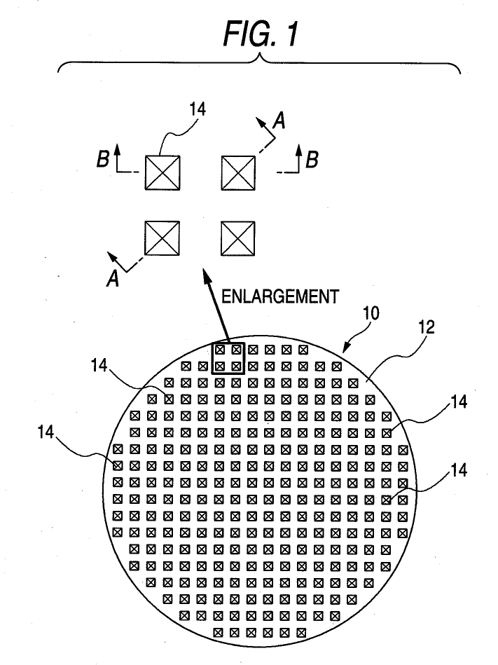

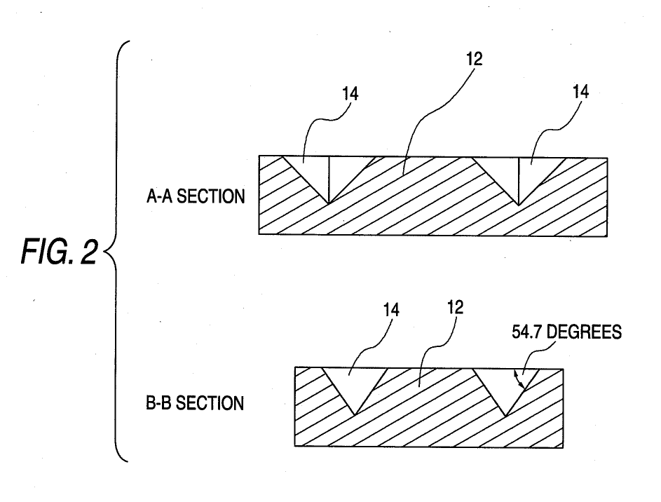

FIG. 1 is a plan view of a solder ball sorter used in a solder ball sorting apparatus in a first embodiment. FIG. 2 is sectional views taken on line A-A and line B-B in FIG. 1.

As respectively shown in FIGS. 1 and 2, the solder ball sorter in the first embodiment is formed in a dimple plate 10 in which concave parts 14 with inverse pyramid shapes (quadrangular pyramid shapes) are arranged in a matrix state on one surface of a single-crystal silicon wafer 12 which is a plate-shaped body made of single-crystal silicon (hereinafter in the present specification, the solder ball sorter is described as the dimple plate 10). The concave part 14 is formed by performing anisotropic etching of the single-crystal silicon wafer 12 using the single crystal silicon wafer 12 in which a plane orientation is a plane (100). Concretely, after the single-crystal silicon wafer 12 with a diameter of 8 inches grown so that the plane orientation becomes the plane (100) is diced in a thickness of 725 μm, one side is polished in a mirror surface state and the wafer 12 is immersed in an etching solution such as a potassium hydroxide solution in a state of bringing a mask (not shown) into close contact with this mirror polish surface and wet etching of an opening portion of the mask is performed and thereby, the concave part 14 is formed.

It is known that the concave part 14 formed by performing wet etching of the single-crystal silicon wafer 12 grown in the plane orientation of the plane (100) thus is etched so as to form an inclination angle of 54.7 degrees with respect to a mask abutment surface of the single-crystal silicon wafer 12 as shown in a section of line B-B of FIG. 2. Therefore, in the case of adjusting a shape dimension of the concave part 14, a depth dimension of the concave part 14 formed finally can be determined by properly adjusting an opening dimension of the mask (not shown). When the wet etching is performed inside the single-crystal silicon wafer 12 thus, the solder ball sorter having the concave parts 14 with uniform shape dimensions can be manufactured at low cost. The dimensions of the concave part 14 in the embodiment are formed in the depth dimension and the opening dimension of the extent to which about one-third the particle diameter of a solder ball B to be captured by the dimple plate 10 is buried in the concave part 14.

An arrangement state of the concave parts 14 in such a dimple plate 10 may be arrangement states other than the matrix state such as staggered arrangement. Also, the dimple plate 10 maybe one dimple plate or it can naturally be constructed of plural dimple plates 10 respectively varied according to the particle diameters of the solder balls B to divide the depth dimension and the opening dimension of the concave part 14 between the mutual dimple plates 10.

In the case of using plural dimple plates 10, the dimple plates 10, 10, . . . arranged in series in order of size of the particle diameter to sort the solder ball B to be sorted could be made to sort the solder balls B in order.

### (Solder Ball Sorting Apparatus)

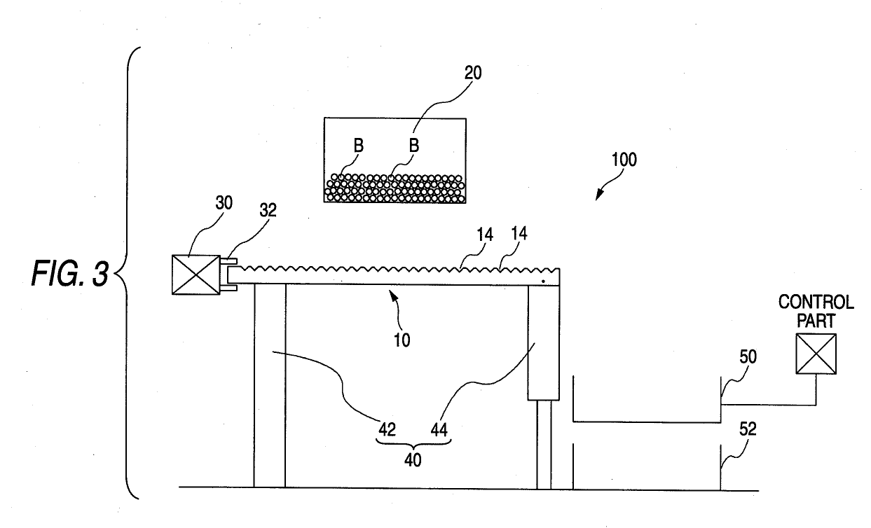

Next, a solder ball sorting apparatus 100 using the dimple plate 10 shown in FIGS. 1 and 2 will be described. FIG. 3 is a schematic configuration view of the solder ball sorting apparatus in the first embodiment.

In the solder ball sorting apparatus 100 shown in FIG. 3, solder balls B are supplied to the dimple plate 10 and by vibrating the dimple plate 10 and the solder balls B, the solder balls B are captured by burying the solder balls B in the concave parts 14 of a surface of the dimple plate 10 and by inclining the dimple plate 10, the solder balls B which are not captured in the concave parts 14 of the dimple plate 10 are eliminated from the dimple plate 10 and the solder balls B are sorted.

The solder ball sorting apparatus 100 comprises the solder ball sorter (dimple plate) 10, a solder ball supply hopper 20 which is a solder ball supply section for supplying solder balls B to the dimple plate 10, a vibrator 30 for giving vibration to the dimple plate 10, an inclination giving section 40 for supporting the dimple plate 10 in a horizontal state and an inclination state, and a first solder ball reception part 50 and a second solder ball reception part 52 which are spherical body reception parts for individually receiving the solder balls B sorted by the solder ball sorter 10. As is evident from the configuration described above, the solder ball sorting apparatus 100 in the embodiment adopts a form of sorting the solder balls B by batch processing.

The inclination giving section 40 for supporting the dimple plate 10 is constructed by a frame 42 whose length does not change, and a fluid cylinder 44 whose length changes. The dimple plate 10 is journaled in the tops of the frame 42 and the fluid cylinder 44 in the bottom. While the length of the frame 42 is constant, the fluid cylinder 44 is disposed expansively and contractively, so that a position of one end of the dimple plate 10 is variably disposed. That is, the dimple plate 10 can be held in both of the horizontal state and the inclination state by changing a length of expansion and contraction of the fluid cylinder 44.

The solder ball supply hopper 20 is disposed in an upward position of the dimple plate 10. The solder ball supply hopper 20 is formed in a box shape in which the upper surface is opened and the bottom surface can be opened and closed, and is disposed so that the required amount of the solder balls B can be supplied to the dimple plate 10 at the time of necessity by controlling an opening and closing operation of the bottom surface. The opening and closing operation of the bottom surface of the solder ball supply hopper 20 is controlled by a control part (not shown). A publicly known shutter opening and closing mechanism in which, for example, a shutter is driven by a fluid cylinder etc. typified by an oil hydraulic cylinder to open and close the shutter could be adopted as an opening and closing mechanism (not shown) of the bottom surface of the solder ball supply hopper 20.

The vibrator 30 is means for giving vibration of a horizontal direction (at least one direction of an X direction or a Y direction in an X-Y plane) to the dimple plate 10 to which the solder balls B are supplied. The vibrator 30 is disposed attachably to and detachably from the dimple plate 10 through a chuck part 32. A period and an amplitude generated by the vibrator 30 are adjusted properly according to mass or a diameter dimension of the solder ball B to be sorted or a dimension of the concave part 14 arranged in the solder ball sorter (dimple plate) 10.

The fluid cylinder 44 becomes an expansion state while giving of vibration by the vibrator 30 is completed after the solder balls B are supplied to the dimple plate 10, and holds the dimple plate 10 so that the dimple plate 10 becomes a horizontal state together with the frame 42. After giving of vibration by the vibrator 30 is completed, the fluid cylinder 44 contracts and holds the dimple plate 10 so as to become an inclination state together with the frame 42. The fluid cylinder 44 in the embodiment contracts to lengths of expansion and contraction of two steps and can adjust the inclination state of the dimple plate 10 in the two steps.

As shown in FIG. 3, the first solder ball reception part 50 and the second solder ball reception part 52 are arranged in the downstream side of the dimple plate 10 so as to have an upper and lower position relation in a state of inclining the dimple plate 10. The first solder ball reception part 50 arranged in the upper stage side among the first solder ball reception part 50 and the second solder ball reception part 52 is formed in a box shape in which the upper surface is opened and the bottom surface can be opened and closed in a manner similar to the solder ball supply hopper 20. An opening and closing operation of the bottom surface in the first solder ball reception part 50 is controlled by a control part (not shown) so as to operate according to a contraction state of the fluid cylinder 44. The second solder ball reception part 52 arranged in the lower stage side is formed in a simple box shape in which the upper surface is opened.

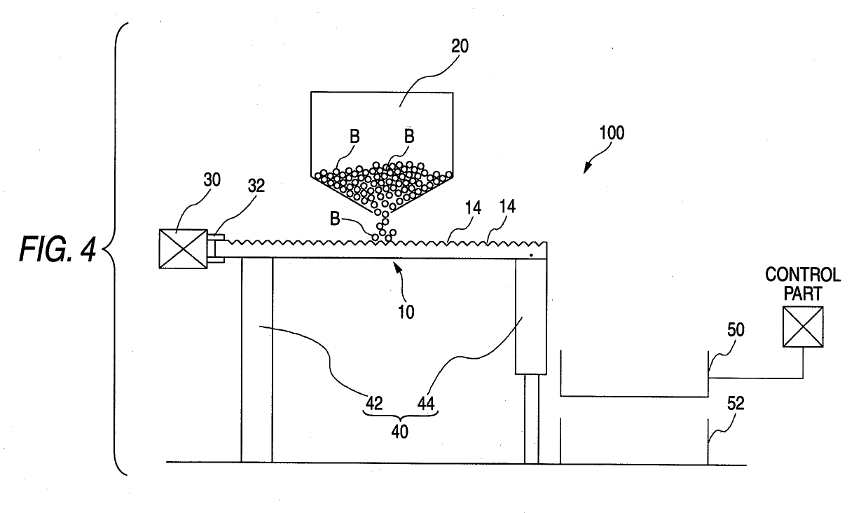

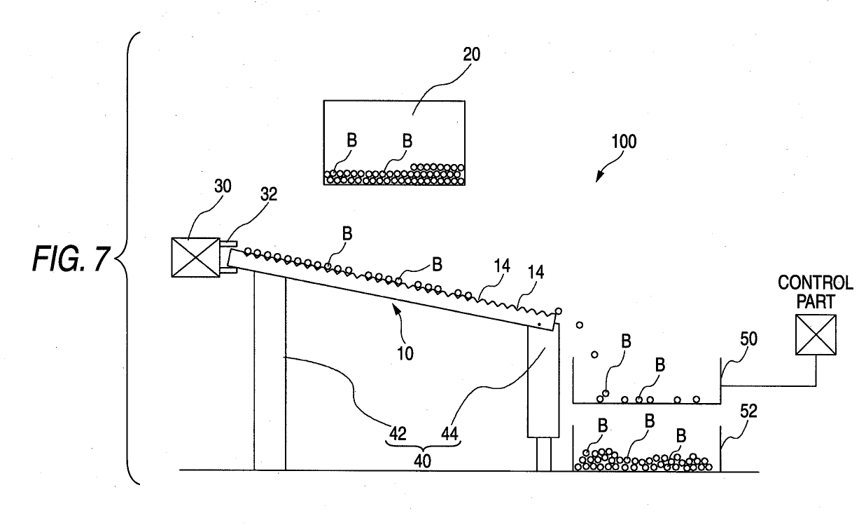

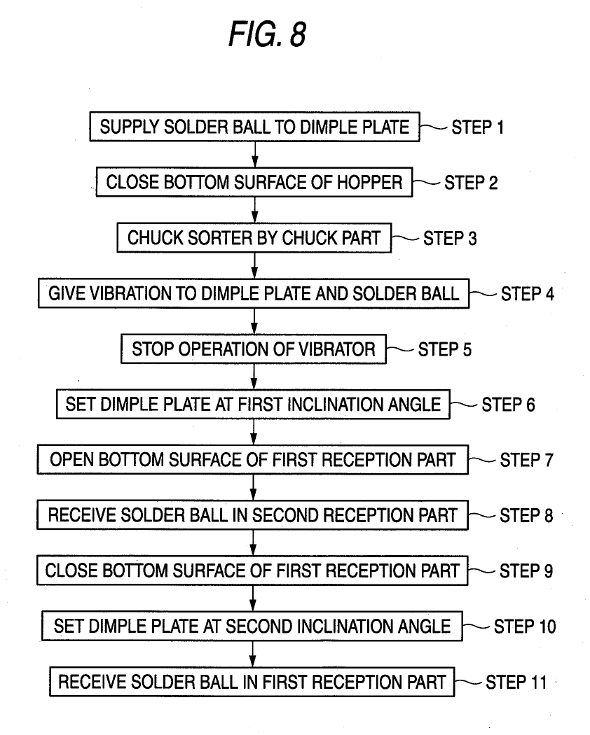

Next, a solder ball sorting method using the solder ball sorting apparatus 100 according to the embodiment will be described using FIGS. 4 and 8. FIGS. 4 and 7 are views showing states of the solder ball sorting apparatus in each of the steps of the solder ball sorting method in the embodiment. FIG. 8 is a flow view showing a procedure of the solder ball sorting method in the embodiment.

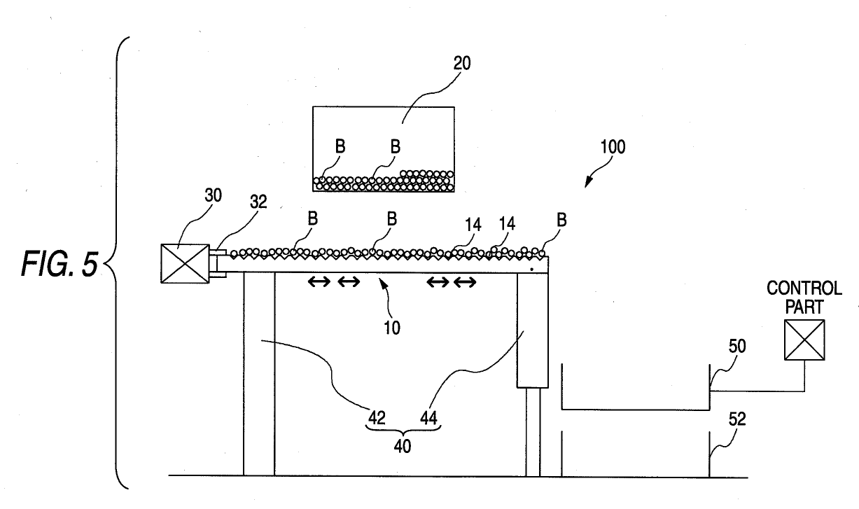

First, as shown in FIG. 4, a control part (not shown) opens the bottom surface of the solder ball supply hopper 20, and supplies the required amount of solder balls B to the solder ball sorter (dimple plate) 10 (step 1). Next, the control part closes the bottom surface of the solder ball supply hopper 20 (step 2) and chucks the dimple plate 10 by the chuck part 32 of the vibrator 30 (step 3) and thereafter, as shown in FIG. 5, the vibrator 30 is actuated and vibration is given to the dimple plate 10 and the solder balls B supplied to the dimple plate 10 for a necessary time (step 4). By giving the vibration to the dimple plate 10 and the solder balls B thus, the solder balls B are divided into the balls which are buried in the concave parts 14 on a surface of the dimple plate 10 and are captured and the balls which are not buried and are not captured.

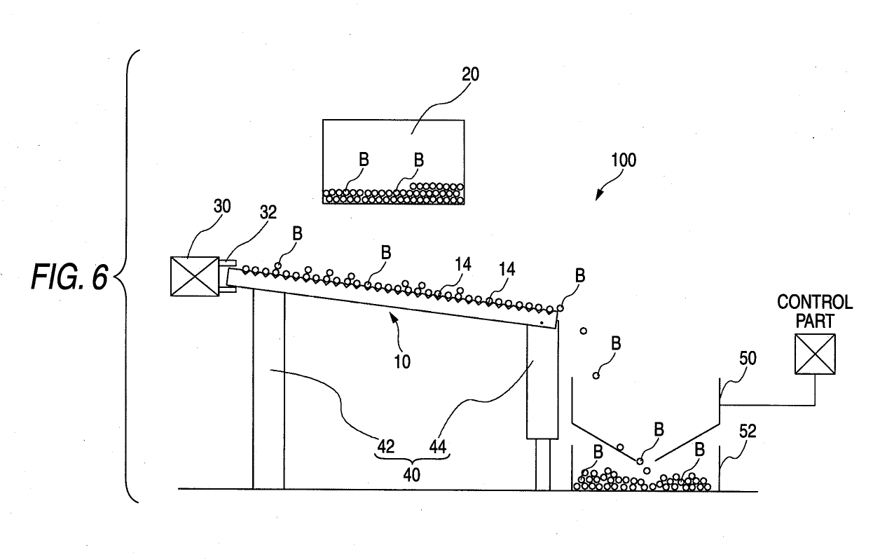

Subsequently, after giving of the vibration by the vibrator 30 is stopped (step 5), as shown in FIG. 6, the control part opens the chuck part 32 and contracts the fluid cylinder 44 to a length of expansion and contraction of the first step and thereby inclines the dimple plate 10 at a first inclination angle (step 6). After the fluid cylinder 44 is contracted so as to become the length of expansion and contraction of the first step, the control part opens the bottom surface of the first solder ball reception part 50 arranged in the upper stage among the first and second solder ball reception parts 50, 52 (step 7).

By inclining the dimple plate 10, the solder balls B which are not buried in the concave parts 14 and are not captured by the solder ball sorter (dimple plate) 10 among the solder balls B supplied to the surface of the dimple plate 10 drop from the lower end of the dimple plate 10 and thereafter pass the first solder ball reception part 50 of the upper stage and are received in the second solder ball reception part 52 of the lower stage (step 8).

After the dimple plate 10 is set at the first inclination angle and the solder balls B which are not buried in the concave parts 14 and are not captured by the dimple plate 10 are received in the second solder ball reception part 52, the control part closes the bottom surface of the first solder ball reception part 50 of the upper stage (step 9) and subsequently contracts the fluid cylinder 44 so as to become a length of expansion and contraction of the second step and inclines the dimple plate 10 at a second inclination angle with an inclination steeper than the first inclination angle as shown in FIG. 7 (step 10). The second inclination angle is inclined at an inclination angle of the extent to which the solder balls B which are buried in the concave parts 14 of the dimple plate 10 and are captured can be dropped from the solder sorter 10 after the solder balls B are taken out of the concave parts 14. The solder balls B which are captured by the dimple plate 10 are received in the first solder ball reception part 50 arranged in the upper stage (step 11).

In the manner as described above, the solder balls B supplied to the solder ball sorting apparatus 100 can be sorted. When the solder balls B received in the first solder ball reception part 50 and the second solder ball reception part 52 are taken out, the solder balls B received in at least the first solder ball reception part 50 can be used as the solder balls B having a standardized dimension.

Some solder balls B received in the second solder ball reception part 52 are received in the second solder ball reception part 52 as a nonstandard dimension because empty concave parts 14 are absent though the solder balls B have a dimension to be buried in the concave parts 14 of the dimple plate 10 and be captured essentially. With respect to this, the solder balls B received in the second solder ball reception part 52 are again supplied to the dimple plate 10 and sorting processing of the solder balls B by the solder ball sorting apparatus 100 is performed and thereby loss of the solder balls B can be reduced, so that this is advantageous.

Also, in the first embodiment described above, the form of controlling an opening and closing state of the bottom surface of the solder ball supply hopper 20 in which a large amount of solder balls B are received is adopted as the form of supply of the solder balls B from the solder ball supply hopper 20 to the solder sorter 10, but the amount capable of one batch processing of the solder sorter 10 may be previously measured to supply the solder balls B to the dimple plate 10 every batch processing. By adopting this form, the fear that the solder balls B of a dimension within standards are mixed in the second solder ball reception part 52 is reduced, so that this is advantageous.

### Second Embodiment

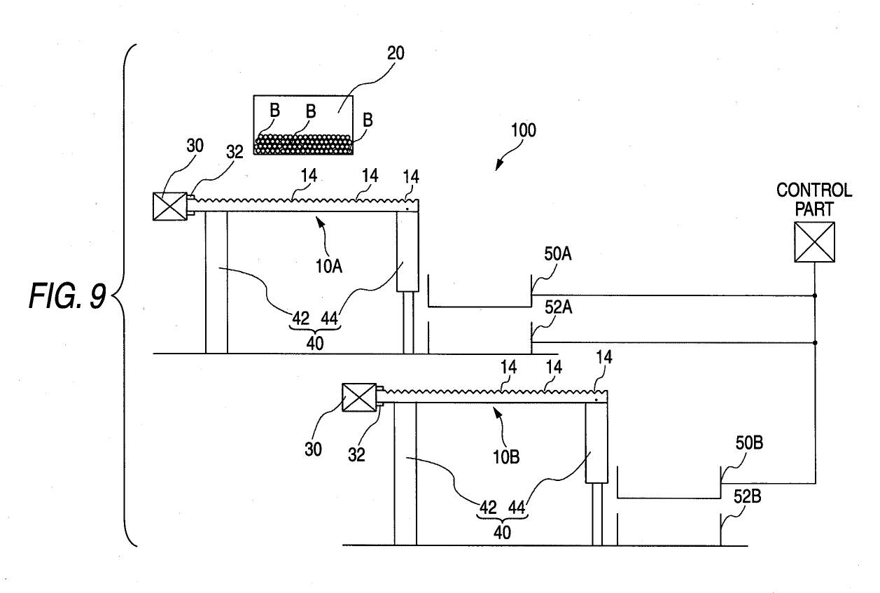

In the first embodiment, the solder ball sorting apparatus 100 using the dimple plate 10 made of one dimple plate is described, but a form of adopting dimple plates 10 constructed by plural dimple plates will be described in the present embodiment. FIG. 9 is a schematic configuration view of a solder ball sorting apparatus in the present embodiment. The solder ball processing apparatus 100 in the first embodiment is suitable in the case of more finely sorting solder balls B in which a particle diameter dimension is previously sorted to a certain extent. On the other hand, in a solder ball processing apparatus 100 in the present embodiment, plural dimple plates 10A, 10B are arranged in series in order of advancing sorting processing of solder balls B, so that the solder balls B can be sorted in plural steps.

The dimple plates 10 in the embodiment are constructed by two dimple plates 10A, 10B. A dimension of a concave part 14 arranged in the other dimple plate 10B is formed larger than a dimension of a concave part 14 arranged in one dimple plate 10A.

Also, two sets of first solder ball reception parts 50A, 52A and second solder ball reception parts 50B, 52B are arranged for each of the dimple plates 10A, 10B. In the embodiment, bottom surfaces of the solder ball reception parts 50A, 52A, 50B are disposed openably and closably. Also, the second solder ball reception parts 52A of the upstream side in solder ball sorting processing is arranged in a position relation capable of supplying the received solder balls B to the dimple plate 10B of the downstream side. That is, the second solder ball reception parts 52A of the upstream side also functions as a solder ball supply section for the dimple plate 10B of the downstream side.

According to the solder ball processing apparatus 100 in the embodiment, solder balls B are supplied to the first dimple plate 10A and sorting processing of the solder balls B is performed in a manner similar to the first embodiment and thereby, the solder balls B capable of being classified as the smallest particle diameter are received in the first solder ball reception part 50A in the upstream side. After the solder balls B which are not buried in the concave parts 14 of the dimple plate 10A of the upstream side and are not captured are once received in the second solder ball reception parts 52A of the upstream side, the solder balls B are supplied to the dimple plate 10B of the downstream side and sorting processing of the solder balls B using the dimple plate 10B is executed. Then, the solder balls B capable of being classified as the second smallest particle diameter are received in the first solder ball reception part 50B in the downstream side and the solder balls B capable of being classified as the largest particle diameter are received in the second solder ball reception part 52B in the downstream side, respectively.

Also, in the second embodiment, the dimension of the concave part 14 in the dimple plate 10B arranged in the downstream side in the case of performing the sorting processing of the solder balls B is formed in a dimension larger than the dimension of the concave part 14 in the dimple plate 10A arranged in the upstream side, but a form in which the solder balls B which are buried in the concave parts 14 in the dimple plate 10A of the upstream side and are captured are supplied to the dimple plate 10B of the downstream side while the dimension of the concave part 14 in the dimple plate 10B arranged in the downstream side is made smaller than the dimension of the concave part 14 in the dimple plate 10A arranged in the upstream side may be adopted. When the dimension of the concave part 14 in the dimple plate 10B arranged in the downstream side is formed in a dimension capable of determining whether or not the solder ball B has the minimum particle diameter or more, the solder ball B with a dimension falling below the minimum particle diameter set can be removed in the solder balls B which are buried in the concave parts 14 in the dimple plate 10A of the upstream side and are captured, so that the sorting processing of the solder balls with higher accuracy can be performed.

The dimple plates 10 in which the dimensions of the concave parts 14 are changed so that order of sorting processing of the solder balls B in the second embodiment is put from smaller particle diameters of the solder balls B to be sorted to gradually larger particle diameters are used, but processing can naturally be performed using dimple plates 10 in which the dimensions of the concave parts 14 are changed so as to put the order from larger particle diameters of the solder balls B to be sorted to gradually smaller particle diameters.

Then, in both the embodiments, the form of taking out the solder balls B which are buried in the concave parts 14 and are captured by only gravity is adopted in the case of contracting the fluid cylinder 44 so as to become the length of expansion and contraction of the second step and inclining the dimple plates 10A, 10B at the second inclination angle, but when a form of giving vibration to the dimple plate 10 by the vibrator 30 is adopted also in the case of setting the dimple plate 10 at the second inclination angle, the solder balls B which are buried in the concave parts 14 and are captured can be taken out without setting the second inclination angle of the dimple plate 10 at an inclination extremely steep with respect to the first inclination angle, so that this is advantageous.

Also, as the dimple plate 10, the single-crystal silicon wafer is used, but a wafer is not necessarily used naturally as long as it is single-crystal silicon.

What is claimed is:

1. A spherical body sorter for sorting spherical bodies having a predetermined diameter dimension, comprising:
a plate-shaped body made of single-crystal silicon, the plate-shaped body having multiple concave parts in a side of one surface of the plate-shaped body, each of the concave parts being formed in the same shape and dimension.

2. A spherical body sorter as claimed in claim 1, wherein the plate-shaped body made of the single-crystal silicon is a single-crystal silicon wafer.

3. A spherical body sorter as claimed in claim 1, wherein in the plate-shaped body made of the single-crystal silicon, a plane orientation is a plane (100).

4. A spherical body sorter as claimed in claim 1, wherein the concave part has a quadrangular pyramid shape.

5. A spherical body sorter as claimed in claim 1, wherein the concave part is formed by performing wet etching with respect to the plate-shaped body made of the single-crystal silicon.

6. A spherical body sorting apparatus comprising:
a spherical body sorter as claimed in claim 1;
a spherical body supply section for supplying spherical bodies to the spherical body sorter;
a vibrator for giving vibration to the spherical body sorter;
an inclination giving section for inclining the spherical body sorter;
a spherical body reception part for individually receiving the spherical bodies sorted by the spherical body sorter; and
a control part for executing a sorting processing in which after the spherical body supply section supplies spherical bodies to the spherical body sorter, the vibrator gives vibration to the spherical body sorter to which the spherical bodies are supplied, the inclination giving section inclines the spherical body sorter to which the spherical bodies are supplied, and the spherical body reception part receives the spherical bodies.

7. A spherical body sorting apparatus comprising:
a plurality of spherical body sorters as claimed in claim 1 arranged in series in a direction of sorting processing of the spherical bodies to stepwise sort spherical bodies;
a spherical body supply section for supplying the spherical bodies to the spherical body sorters;
a vibrator for individually giving vibration to the plurality of spherical body sorters;
an inclination giving section for individually inclining the plurality of spherical body sorters;
a spherical body reception part for individually receiving the spherical bodies sorted by the plurality of spherical body sorters; and
a control part for executing a sorting processing in which after the spherical body supply section supplies spherical bodies to the spherical body sorters, the vibrator gives vibration to the spherical body sorters to which the spherical bodies are supplied, the inclination giving section inclines the spherical body sorters to which the spherical bodies are supplied, and the spherical body reception part receives the spherical bodies.

8. A spherical body sorting apparatus as claimed in claim 7, wherein dimensions of the concave parts disposed in the plurality of spherical body sorters become larger or smaller stepwise in the direction of sorting processing of the spherical bodies.

9. A spherical body sorting apparatus as claimed in claim 7, wherein spherical bodies received in the spherical body reception part are supplied to another spherical body sorter arranged in the downstream side of a spherical body sorter which sorted the spherical bodies, and the control part executes the sorting processing with respect to the another spherical body sorter.

10. A spherical body sorting apparatus as claimed in claim 8, wherein spherical bodies received in the spherical body reception part are supplied to another spherical body sorter arranged in the downstream side of a spherical body sorter which sorted the spherical bodies, and the control part executes the sorting processing with respect to the another spherical body sorter.

11. A spherical body sorting apparatus as claimed in claim 7, wherein a plurality of spherical body reception parts are arranged for the one spherical body sorter, and
wherein the control part executes the sorting processing in which spherical bodies which are not captured in concave parts of the spherical body sorter are received in a first spherical body reception part by inclining the spherical body sorter to which the spherical bodies are supplied at a first inclination angle by the inclination giving section and thereafter the spherical bodies captured in the concave parts of the spherical body sorter are received in a second spherical body reception part by inclining the spherical body sorter to which the spherical bodies are supplied at a second inclination angle with an inclination steeper than the first inclination angle.

12. A spherical body sorting apparatus as claimed in claim 8, wherein a plurality of spherical body reception parts are arranged for the one spherical body sorter, and
wherein the control part executes the sorting processing in which spherical bodies which are not captured in concave parts of the spherical body sorter are received in a first spherical body reception part by inclining the spherical body sorter to which the spherical bodies are supplied at a first inclination angle by the inclination giving section and thereafter the spherical bodies captured in the concave parts of the spherical body sorter are received in a second spherical body reception part by inclining the spherical body sorter to which the spherical bodies are supplied at a second inclination angle with an inclination steeper than the first inclination angle.

13. A spherical body sorting method, comprising:
a sorting processing including steps of:
supplying spherical bodies to a spherical body sorter as claimed in claim 1;
vibration to the spherical body sorter to which the spherical bodies are supplied;
inclining the spherical body sorter to which the spherical bodies are supplied; and
receiving the spherical bodies sorted by the spherical body sorter in a spherical body reception part.

14. A spherical body sorting method as claimed in claim 13, further comprising:
supplying spherical bodies received in the spherical body reception part to another spherical body sorter arranged in the downstream side of the spherical body sorter;
executing the sorting processing with respect to the another spherical body sorter.

15. A spherical body sorting method as claimed in claim 13, wherein spherical bodies which are not captured in concave parts of the spherical body sorter are received in a first spherical body reception part by inclining the spherical body sorter to which the spherical bodies are supplied at a first inclination angle, and thereafter the spherical bodies captured in the concave parts of the spherical body sorter are received in a second spherical body reception part by inclining the spherical body sorter to which the spherical bodies are supplied at a second inclination angle with an inclination steeper than the first inclination angle.
